(19) United States
(12) Patent Application Publication
(10) Pub. No.: US 2021/0027220 A1
(43) Pub. Date: Jan. 28, 2021

(54) SYSTEM AND METHOD OF PROVIDING CONTEXT BASED PERSONALIZED ASSISTANCE

(71) Applicant: Wipro Limited, Bangalore (IN)

(72) Inventors: Ghulam Mohiuddin Khan, Bangalore (IN); Jayaprakash Sakthivel, Tirupur (IN)

(21) Appl. No.: 16/562,562

(22) Filed: Sep. 6, 2019

(30) Foreign Application Priority Data
Jul. 27, 2019 (IN) 201941030085

(51) Int. Cl. G06Q 10/06; G06F 9/451

(52) U.S. Cl. CPC G06Q 10/06311; G06F 9/453

(57) ABSTRACT

The present invention relates to a method of providing context based personalized assistance. The method includes receiving a request for assisting a user for performing a task. A workflow to the user is provided based on the received request. A multimodal data associated with one or more actions performed by the user while performing each step of the workflow is captured and a context of the one or more actions and an instance of struggle by the user in performing the one or more actions is determined using a machine learning technique. A personalized recommendation for the user for performing the one or more actions is identified in real time and the personalized recommendation is provided to the user for completing the task.

This application claims the benefit of Indian Patent Application Serial No. 201941030085 filed Jul. 27, 2019, which is hereby incorporated by reference in its entirety.

### FIELD

The present disclosure relates to the field of virtual assistance systems. Particularly, but not exclusively, the present disclosure relates to method of providing context based personalized assistance.

### BACKGROUND

Users for performing a task like hardware repair, fault analysis, device diagnostic, and configuring of network and systems, may generally take the help of a textual description, a video, or an audio associated with the task to perform the steps required to complete the task. An assistance system may provide the user with necessary instructions through various mode viz. textual description, the video, or the audio for performing the task. However, the user may struggle or tend to make mistakes at specific instances or at any particular step, while following the instructions. The struggle of the user may be such as using a wrong tool at a specific instance of repairing the appliance, failing to note down readings from the appliance, and the like. Hence, there is a need for personalized assistance to the users based on the context of the struggle while performing tasks.

An issue with the existing techniques is the lack of ability to capture the user interaction data and action logs (step wise—detailed) associated with performing of a task.

Another issue with the existing techniques is the lack of ability to identify the context specific instance of struggle from the captured data.

The information disclosed in this background of the disclosure section is only for enhancement of understanding of the general background of the invention and should not be taken as an acknowledgement or any form of suggestion that this information forms the prior art already known to a person skilled in the art.

### SUMMARY

One or more shortcomings of the prior art are overcome, and additional advantages are provided through the provision of method of the present disclosure.

Additional features and advantages are realized through the techniques of the present disclosure. Other embodiments and aspects of the disclosure are described in detail herein and are considered a part of the claimed disclosure.

Disclosed herein is a method of providing context based personalized assistance, the method includes receiving a request for assisting a user for performing a task. Further, the method includes providing a workflow to the user based on the received request. Furthermore, the method includes receiving multimodal data associated with one or more actions performed by the user while performing each step of the workflow. Thereafter, the method includes determining a context of the one or more actions and an instance of struggle by the user in performing the one or more actions to complete each step of the workflow based on the received multimodal data based on a machine learning technique. Finally, the method includes identifying a personalized recommendation for the user in real time for performing the one or more actions based on the determined context, and the determined instance of struggle, wherein the personalized recommendation is provided to the user for completing the task.

Embodiments of the present disclosure discloses an assistance system, for providing context based personalized assistance, the assistance system includes a processor and a memory communicatively coupled to the processor, where the memory stores the processor executable instructions, which, on execution, causes the processor to receive a request for assisting a user for performing a task. Further, the processor is configured to provide a workflow to the user based on the received request. Furthermore, the processor is configured to receive multimodal data associated with one or more actions performed by the user while performing each step of the workflow. Thereafter, the processor is configured to determine a context of the one or more actions and an instance of struggle by the user in performing the one or more actions to complete each step of the workflow based on the received multimodal data based on a machine learning technique. Finally, the processor is configured to identify a personalized recommendation for the user in real time for performing the one or more actions based on the determined context, and the determined instance of struggle, wherein the personalized recommendation is provided to the user for completing the task.

Further, the present disclosure discloses a non-transitory computer readable medium including instructions stored thereon for providing context based personalized assistance, that when processed by at least one processor cause a device to perform operations including receiving a request for assisting a user for performing a task. Further, providing a workflow to the user based on the received request. Furthermore, receiving multimodal data associated with one or more actions performed by the user while performing each step of the workflow. Thereafter, determining a context of the one or more actions and an instance of struggle by the user in performing the one or more actions to complete each step of the workflow based on the received multimodal data based on a machine learning technique. Finally, identifying a personalized recommendation for the user in real time for performing the one or more actions based on the determined context, and the determined instance of struggle, wherein the personalized recommendation is provided to the user for completing the task.

The foregoing summary is illustrative only and is not intended to be in any way limiting. In addition to the illustrative aspects, embodiments, and features described above, further aspects, embodiments, and features may become apparent by reference to the drawings and the following detailed description.

### BRIEF DESCRIPTION OF THE DRAWINGS

The novel features and characteristic of the disclosure are set forth in the appended claims. The disclosure itself, however, as well as a preferred mode of use, further objectives and advantages thereof, may best be understood by reference to the following detailed description of an illustrative embodiment when read in conjunction with the accompanying drawings. The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. One or more embodiments are now described, by way of example only, with reference to the accompanying figures wherein like reference numerals represent like elements and in which:

FIG. 1 shows an exemplary environment for providing context based personalized assistance, in accordance with some embodiments of the present disclosure.

FIG. 2 shows a detailed block diagram of an assistance system, in accordance with some embodiments of the present disclosure.

FIG. 3 shows a flowchart illustrating method steps for providing context based personalized assistance, in accordance with some embodiment of the present disclosure.

FIG. 4 shows an exemplary workflow provided to the user corresponding to a task, in accordance with some embodiments of the present disclosure.

FIG. 5 shows an exemplary capturing of the multimodal data while user is performing the task using image capturing device, in accordance with some embodiments of the present disclosure.

FIG. 6 shows an exemplary determination of context of the one or more actions performed by the user, in accordance with some embodiments of the present disclosure.

FIG. 7 shows an exemplary sentiment classification using the Support Vector Machine (SVM), in accordance with some embodiments of the present disclosure.

FIGS. 8A and 8B shows an exemplary personalized recommendation provided to the user based on the determined instance of struggle, in accordance with some embodiments of the present disclosure.

FIG. 9 shows an exemplary computer system for providing context based personalized assistance, in accordance with some embodiments of the present disclosure.

It should be appreciated by those skilled in the art that any block diagrams herein represent conceptual views of illustrative systems embodying the principles of the present subject matter. Similarly, it may be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and may be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “includes” “comprising”, “including” or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” or “includes . . . a” does not, without more constraints, preclude the existence of other elements or additional elements in the system or apparatus.

The present disclosure describes a method of providing context based personalized assistance for the user. The method includes receiving a request for assisting a user for performing a task. Further, providing a workflow to the user based on the received request and receiving multimodal data associated with one or more actions performed by the user while performing each step of the workflow. Furthermore, determining a context of the one or more actions and an instance of struggle by the user in performing the one or more actions to complete each step of the workflow based on the received multimodal data based on a machine learning technique. Finally, identifying a personalized recommendation for the user in real time for performing the one or more actions based on the determined context, and the determined instance of struggle, where the personalized recommendation is provided to the user for completing the task.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

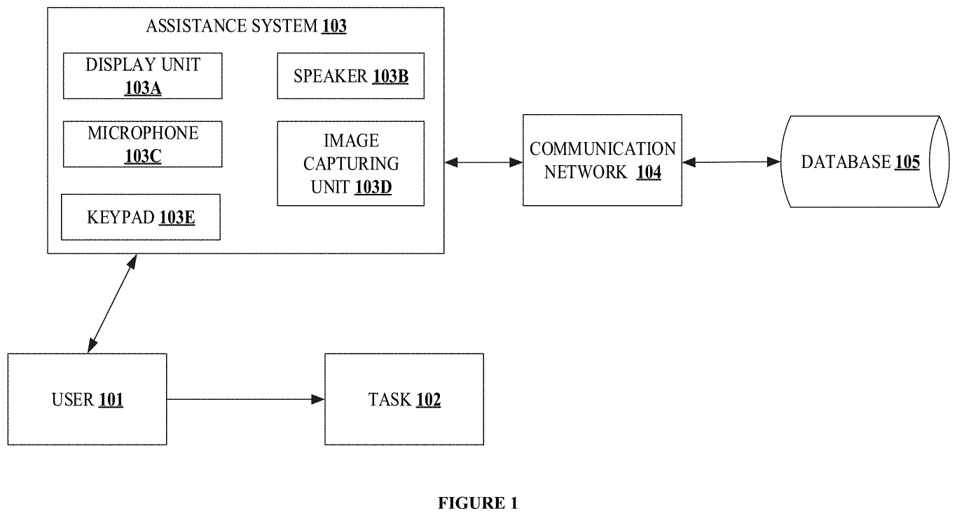

FIG. 1 shows an exemplary environment for providing context based personalized assistance, in accordance with some embodiments of the present disclosure.

In an embodiment, a user (101) may request an assistance to perform a task (102) to the assistance system (103). The user (101) may provide the request to the assistance system (103) as a textual description using a keypad (103E) housed on the assistance system (103) or as a voice message using a microphone (103C) housed on the assistance system (103). Further, based on the request received from the user (101), the assistance system (103) may procure additional information from the user (101). For example, the request from the user (101) may be “Assistance to configure a router in a network” and the additional information procured may be information regarding manufacturer and a model of the router. The assistance system (103) based on the received request, may identify and retrieve a relevant workflow stored in a database (105) via the communication network (104). The workflow may include a step by step procedure for completing the task (102). Each step of the workflow may include one or more actions for completing each step of the workflow. The one or more actions in each step of the workflow may be described using at least one of a video, an image, a textual description, an animation and the like. The database (105) may store one or more workflows corresponding to a plurality of the tasks. The workflow may be provided to the user (101) using at least one of a display unit (103A) by displaying the video, the animation, the image, and the textual description, and a speaker (103B) by rendering the audio or a voice message. The user (101) may perform one or more actions based on the rendered workflow for completing the task (102). For example, the steps of the workflow for the task (102) of configuring the router in a network may be as given below:
“Step 1: Connect the router to the network.
Step 2: Connect to the router from a computer using the IP address 192.168.1.1.
Step 3: Login to the router portal using a username and password
Step 4: Set up the network name.
Step 5: Select the encryption technique.
Step 6: Set the password complying with the selected encryption technique
Step 7: Log out.”

Further, the assistance system (103) may record and receive multimodal data associated with the one or more actions performed by the user (101) while performing each step of the workflow. The multimodal data of the user (101) includes at least one of a captured image, a captured video, a recorded audio, action logs or interacted text with the assistance system (103). The multimodal data of the user (101) may be recorded and received by the assistance system (103) using at least one of an image capturing unit (103D) for images and the video, the microphone (103C) for audio or voice messages and the keypad (103E) for the textual messages. The assistance system (103) may determine a context of the one or more actions performed by the user (101) using the received multimodal data of the user (101). The determined context may have information about what is being performed by the user (101) or what is going on in the frame sequences of the captured video. For example, consider configuring the router in a network, the assistance system (103) may identify the context based on the received multimodal data of the user (101) as given below:
“the user (101) successfully connected the router to a network and has completed remote login procedure to the router from a computer device, and further the user (101) is setting a network name for the wireless interface”.

The assistance system (103) may determine an instance of struggle, if any, by the user (101) in performing the one or more actions to complete each step of the workflow based on the received multimodal data using a machine learning technique. For example, consider configuring the router in a network, the assistance system (103) may identify the instance of struggle based on the received multimodal data and the determined context as given below:
“the user (101) is not able to select an encryption technique from a plurality of encryption techniques in the router setting, for setting a password to the network login”

Furthermore, the assistance system (103) may identify a personalized recommendation for the user (101) in real time for performing the one or more actions based on the determined context, and the determined instance of struggle. The personalized recommendation provided to the user (101) may include at least one of an audio suggestion, a video suggestion, a text suggestion, suggestion through animation, or a suggestion through an image. The identified personalized recommendation may be retrieved form the database (105) via a communication network (104) and provided to the user (101) using at least one of the display unit (103A) and the speaker (103B). For example, consider configuring the router in a network, the assistance system (103) may provide a textual or the audio personalized recommendation as given below:
“use a Wi-Fi Protected Access (WPA) as an encryption technique over Wired Equivalent Privacy (WEP) is preferable to make the network more secure. Also, minimum characters for the WPA encryption technique is 8”.

The user (101) based on the personalized assistance system (103) may complete the task (102) by performing one or more actions successfully.

In an embodiment, the assistance system (103) may be housed in a digital device held by the user (101), as the user (101) wearable digital device, as the digital device mounted on a wall or a stand and the like.

In an embodiment, the digital device may comprise the display unit (103A), the speaker (103B), the microphone (103C), the image capturing unit (103D) and the keypad (103E). The assistance system (103) may be hosted on a server. Further, the assistance system (103) may be communicatively coupled to the digital device via a communication network (104).

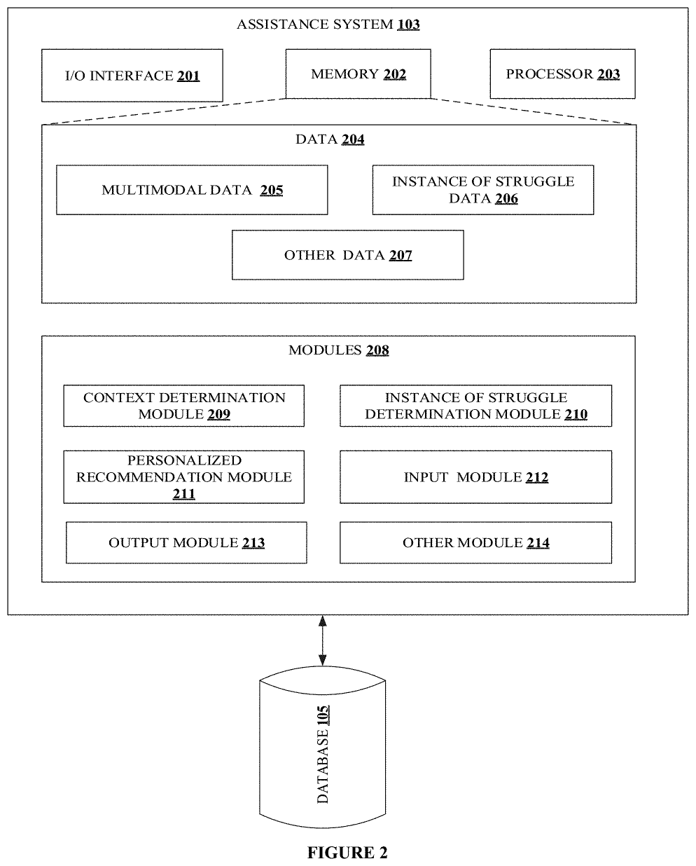

FIG. 2 shows a detailed block diagram of the assistance system (103), in accordance with some embodiments of the present disclosure.

The assistance system (103) may include a Central Processing Unit (“CPU” or “processor”) (203) and a memory (202) storing instructions executable by the processor (203). The processor (203) may include at least one data processor for executing program components for executing user or system-generated requests. The memory (202) may be communicatively coupled to the processor (203). The assistance system (103) further includes an Input/Output (I/O) interface (201). The I/O interface (201) may be coupled with the processor (203) through which an input signal or/and an output signal may be communicated. In one embodiment, the assistance system (103) may receive the request for assisting the user (101) for performing the task (102) and the multimodal data of the user (101) through the I/O interface (201).

In some implementations, the assistance system (103) may include data (204) and modules (208). As an example, the data (204) and modules (208) may be stored in the memory (202) configured in the assistance system (103) as shown in the FIG. 2. In one embodiment, the data (204) may include, for example, a multimodal data (205), instance of struggle data (206), and other data (207). In the illustrated FIG. 2, data (204) are described herein in detail.

In an embodiment, the multimodal data (205) of the user (101) may include at least one of a captured image, a captured video, a recorded audio, action logs or interacted text with the assistance system (103). The image and the video may be captured and stored by the assistance system (103) while the user (101) is performing one or more actions at each step of the workflow. Further, the audio may be recorded using the microphone (103C) and the interacted text from the user (101) may be received from the keypad (103E) while the user (101) is performing one or more actions at each step of the workflow.

In an embodiment, the instance of struggle data (206) may include one or more actions of the user (101) identified by the machine learning algorithm where the user (101) may take additional time as compared with a predetermined time for completing the one or more actions. Further, the instance of struggle data (206) may include the one or more actions of the user (101) where the user (101) may fail to perform the one or actions at each step of the workflow and may request the assistance system (103) for additional information.

In an embodiment, the other data (210) may include one or more parameters associated with the machine learning algorithms for example Convolution Neural Network (CNN) (601), Support Vector Machine (SVM), Long Short-Term Memory (LSTM) (602) and the like.

In some embodiments, the data (204) may be stored in the memory (202) in form of various data structures. Additionally, the data (204) may be organized using data models, such as relational or hierarchical data models. The other data (207) may store data, including temporary data and temporary files, generated by the modules (208) for performing the various functions of the assistance system (103).

In some embodiments, the data (204) stored in the memory (202) may be processed by the modules (208) of the assistance system (103). The modules (208) may be stored within the memory (202). In an example, the modules (208) may be communicatively coupled to the processor (203) configured in the assistance system (103), may also be present outside the memory (202) as shown in FIG. 2 and implemented as hardware. As used herein, the term modules (208) may refer to an Application Specific Integrated Circuit (ASIC), a FPGA (Field Programmable Gate Array), an electronic circuit, a processor (shared, dedicated, or group) and memory (202) that execute one or more software or firmware programs, a combinational logic circuit, and/or other suitable components that provide the described functionality. In some other embodiments, the modules (208) may be implemented using at least one of ASICs and FPGAs.

In one implementation, the modules (208) may include, for example, a context determination module (209), an instance of struggle determination module (210), a personalized recommendation module (211), an input module (212), an output module (213), and other module (214). It may be appreciated that such aforementioned modules (208) may be represented as a single module or a combination of different modules.

In an embodiment, the context determination module (209) may be used to determine a context of the one or more actions and an instance of struggle by the user (101) in performing the one or more actions to complete each step of the workflow based on the received multimodal data (205) based on a machine learning technique. The context determination module (209) may detect at least one of one or more objects, and state of the one or more objects in the received multimodal data (205). Further, the assistance system (103) may detect the one or more actions performed by the user (101) on the one or more objects. Furthermore, the assistance system (103) may generate a textual description based on the detected one or more actions and at least one of the one or more objects, and the state of the one or more objects. Finally, the assistance system (103) may determine the context of the one or more actions using the generated textual description and a domain specific rule. The domain specific rule may be pre-defined manually using a collected dataset of domain specific similar interactions and stored in the database (105). For example, consider the task (102) of “Assistance to configure a router in a network”. The domain of the task (102) may be identified as configuring of network and systems and the domain specific rules may include interactions between the entities of the collected dataset. The dataset for the domain configuring of network and systems may include “router, switches, computer systems, ethernet cables, protocol configuration tools like Wireshark® and the like”. The domain specific rules may include “plugging in or plugging out of the ethernet cables to the router or computer systems, capturing network packets using the protocol configuration tools, procedure to perform telnet from the computer system to remotely connect to the router in the network and the like”.

In an embodiment, the instance of struggle determination module (210) may be used to determine the instance of struggle by the user (101) in performing the one or more actions to complete each step of the workflow based on the received multimodal data (205) using a machine learning technique. The assistance system (103) may determine a sentiment of the user (101) based on the received multimodal data (205), using a machine learning technique for example Support Vector Machine (SVM). The sentiment of the user (101) may be classified as a positive sentiment, a negative sentiment, and a neutral sentiment. Further, the assistance system (103) may identify the instance of struggle by the user (101) based on the determined sentiment, and the determined context. In an embodiment, the negative sentiment may denote the instance of struggle by the user (101). For example, the user (101) trying out different tools to perform one or more actions may be treated as a negative sentiment and hence identified as an instance of struggle. In another example, the user (101) with an anxious facial expression may be treated as a negative sentiment and hence identified as an instance of struggle.

In an embodiment, the personalized recommendation module (211) may be used to select one or more personalized recommendation from a plurality of personalized recommendation stored in the database (105). The personalized recommendation provided to the user (101) includes at least one of an audio suggestion, a video suggestion, a text suggestion, suggestion through animation, or a suggestion through an image. Further, the personalized recommendation may be selected based on the determined context and the determined instance of struggle by the user (101) to complete a step of the workflow.

In an embodiment, the input module (212) may be used to receive the request from the user (101) for assistance for performing a task (102). The input module (212) may further receive multimodal data (205) of the user (101), while the user (101) is performing the one or more actions at each step of the workflow. The input module (212) may include a microphone (103C) for receiving the audio or voice message from the user (101). Further, the input module (212) may include a keypad (103E) for receiving a textual descriptions from the user (101) and the image capturing unit (103D) for receiving the captured one or more images and captured video while the user (101) is performing the one or more actions at each step of the workflow.

In an embodiment, the output module (213) may be used to provide the workflow corresponding to the task (102) to the user (101). Further, the output module (213) may be used to provide the personalized assistance for the identified instance of struggle performed by the user (101). The output module (213) may use the display unit (103A) for providing the workflow and the personalized assistance in the format of the image, the video or the textual description to the user (101). Further, the output module (213) may use the speaker (103B) for providing the workflow and the personalized assistance in the format of the audio or a voice message to the user (101).

In an embodiment, the other module (214) may be used to retrieve a workflow corresponding to the task (102) from the database (105). Further, the other module (214) may be used to retrieve the personalized recommendation from the database (105). Furthermore, the other module (214) may be used to analyze the request of the user (101) using one or more machine learning and natural language processing techniques and select a workflow from the plurality of workflows stored in the database (105).

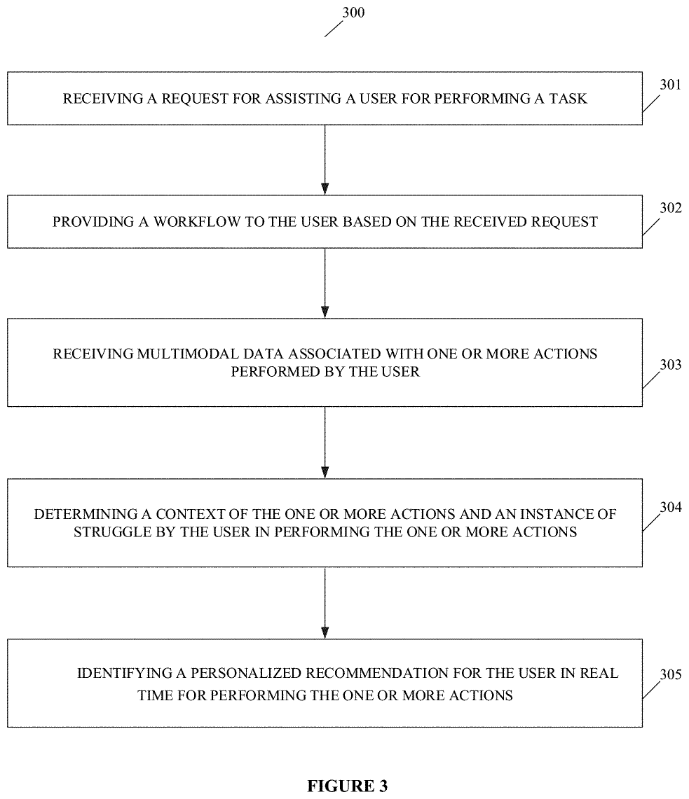

FIG. 3 shows a flowchart illustrating method steps for providing context based personalized assistance, in accordance with some embodiment of the present disclosure.

The order in which the method 300 may be described is not intended to be construed as a limitation, and any number of the described method blocks may be combined in any order to implement the method. Additionally, individual blocks may be deleted from the methods without departing from the scope of the subject matter described herein. Furthermore, the method may be implemented in any suitable hardware, software, firmware, or combination thereof.

At the step 301, the assistance system (103) may receive a request for assisting a user (101) in performing a task (102). The task (102) may include a hardware repair, fault analysis in hardware and software systems, device diagnostics, configuring network and systems and the like. For example, debugging a log file, replace a flat tire of an automobile, configure a router in a network, replacing a leaking water tap and the like.

Consider the task (102) “Removal of hard disk of a given laptop”, where the user (101) may request the assistance system (103) for assistance to complete the task (102). Further, the assistance system (103) may request and procure additional information by interacting with the user (101) for example, “the manufacturer and the model of the laptop” using input module (212) and the output module (213).

At the step 302, the assistance system (103) may provide a workflow to the user (101) based on the received request. For each task (102) a corresponding workflow may be stored in the database (105). The workflow may include a step by step procedure to complete the task (102). Each step of the workflow may include one or more actions to be performed by the user (101) for completing the task (102). Further, the assistance system (103) may retrieve the workflow corresponding to the task (102) from the database (105) via the communication network (104). The retrieved workflow from the database (105) may include at least one of an image, a text description, a video, an animation or a combination of the same at each step of the workflow. Further, the retrieved workflow may be provided to the user (101) as assistance for completing the task (102) as requested by the user (101).

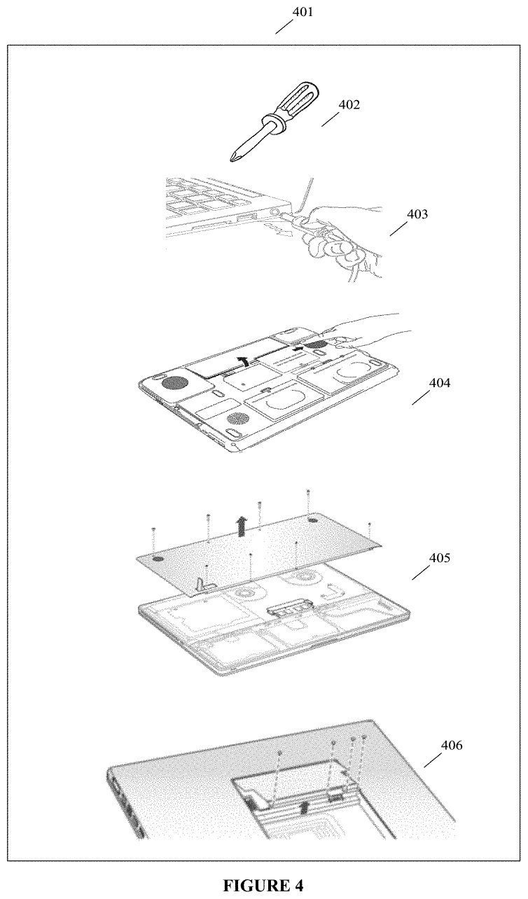

As shown in FIG. 4, the workflow (401) corresponding to the task (102) “Removal of hard disk of a given laptop” may be provided to the user (101). The workflow (401) may be retrieved by the assistance system (103) from the database (105) via the communication network (104). The workflow (401) details the step by step procedure to complete the task (102) “removal of hard disk of a given laptop”. Each step of the workflow (401) may include one or more actions to be performed by the user (101) as given below:
“Step 1 (402): collect the tool: jeweler's screwdriver
Step 2 (403): remove all the cables connected to the laptop
Step 3 (404): remove the battery by sliding the tabs and push the battery away from the laptop
Step 4 (405): remove the screws at the back of the laptop and remove the back cover of the laptop
Step 5 (406): locate the hard drive, remove the hard drive screws and the hard drive”.

Referring back to FIG. 3, at the step 303, the assistance system (103) may receive multimodal data (205) associated with one or more actions performed by the user (101) while performing each step of the workflow. The multimodal data (205) of the user (101) comprises at least one of the captured image, the captured video, the recorded audio, the action logs or the interacted text with the assistance system (103).

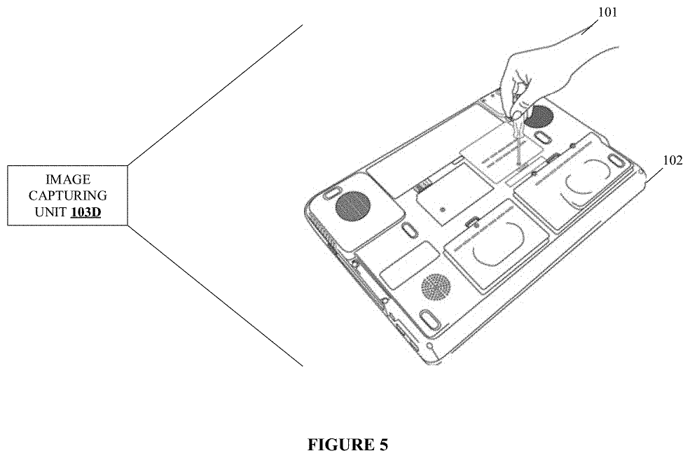

As shown in FIG. 5, the image processing unit (103D) may capture the multimodal data (205) i.e. captured video or captured image of the user (101) while the user (101) is performing one or more actions at each step of the workflow (401). The assistance system (103) may receive the captured multimodal data (205) from the image capturing unit (103D).

Referring back to FIG. 3, at the step 304, the assistance system (103) may determine a context of the one or more actions and an instance of struggle by the user (101) in performing the one or more actions to complete each step of the workflow based on the received multimodal data (205) based on a machine learning technique.

The assistance system (103) may detect at least one of one or more objects, and state of the one or more objects in the received multimodal data (205). Further, the assistance system (103) may detect the one or more actions performed by the user (101) on the one or more objects. Furthermore, the assistance system (103) may generate a textual description based on the detected one or more actions and at least one of the one or more objects, and the state of the one or more objects. Finally, the assistance system (103) may determine the context of the one or more actions using the generated textual description and a domain specific rule.

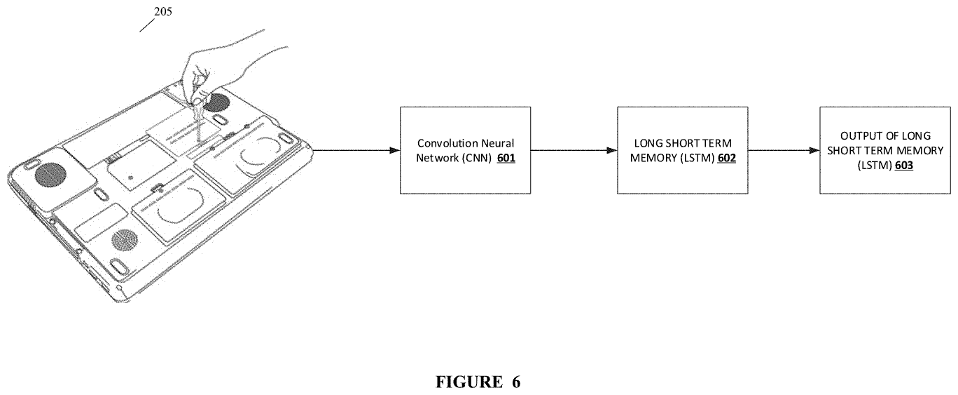

In an embodiment, the Convolution Neural Network (CNN) (601) based visual detection model may be used to detect at least one of one or more objects, and state of the one or more objects in the received multimodal data (205). The CNN (601) may be pre trained using the multimodal data (205) of the user (101). As shown in FIG. 6, the received multimodal data (205) i.e. captured image or captured video of the user (101) performing one or more actions at a step of the workflow (401) may be fed to the CNN (601) detection model. The CNN (601) detection model may identify one or more objects in the received multimodal data (205) for example, user (101) hand, screwdriver, laptop and the like. Further, the CNN (601) detection model may identify state of the one or more objects in the received multimodal data (205) and detect the one or more actions performed by the user (101) for example, battery removed from the laptop, user (101) unscrewing the back cover of the laptop and the like.

In an embodiment, the Long Short-Term Memory (LSTM) (602) based language model may be used to generate textual descriptions from the detected one or more actions of the user (101) and at least one of the one or more objects, and the state of the one or more objects. The LSTM (602) may be pre-trained using the multimodal data (205) of the user (101). For example, the output of the LSTM (603) as shown in FIG. 6 may be as given below:
“the user (101) has completed the steps 1 (402) to step 3 (404) in the workflow and is performing the step 4 (405) of removing the screws at the back of the laptop and removing the back cover of the laptop”.

In another embodiment, the Long Short Term Memory (LSTM) (602) based language model may be used to generate textual descriptions from the received multimodal data (205) where the multimodal data (205) may include at least one of the captured audio or voice message, the action logs indicating the timestamp of the start of the each step of the workflow, timestamp of the completion of each step of the workflow, the number of steps completed by the user (101) in the workflow and the textual description from the user (101).

In an embodiment, the assistance system (103) may determine the context of the one or more actions using the generated textual description and a domain specific rule. The domain specific rule may be pre-defined manually using a collected dataset of domain specific similar interactions and stored in the database (105). For example, consider the task (102) of “Removal of hard disk of a given laptop”. The domain of the task (102) may be identified as hardware repair of computer systems and the domain specific rules may include interactions between the entities of the collected dataset. The dataset for the domain hardware repair of computer systems may include laptop, back cover, screwdriver, bracket, cables, clips, socket pin and the like. The domain specific rules may include plugging in or plugging out of the cables to the laptop, removing the battery, sliding the clips, unscrewing using a screwdriver, remove the cable from the socket pin and the like. Further, the assistance system (103) may determine the context as “User is performing the unscrewing of the screws on the back cover of the laptop at the step 4 (405) of the workflow”.

Further, the assistance system (103) may determine the instance of struggle by the user (101) in performing the one or more actions to complete each step of the workflow based on the received multimodal data (205). The assistance system (103) may determine a sentiment of the user (101) based on the received multimodal data (205), using a machine learning technique. Further, the assistance system (103) may identify the instance of struggle by the user (101) based on the determined sentiment, and the determined context.

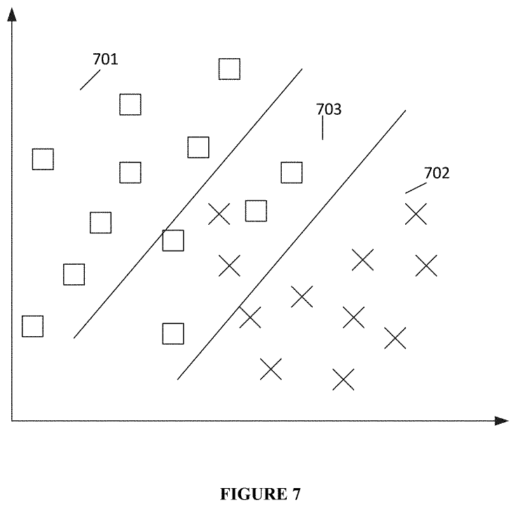

In an embodiment, Support Vector Machine (SVM) may be used to determine the sentiment of the user (101). From the received multimodal data (205) of the user (101), one or more features for example, the facial expressions of the user (101), the time taken by the user (101) to perform the one or more actions of the workflow, words determined from the captured audio or the voice message may be used to determine the sentiment of the user (101). In FIG. 7, x-axis and y-axis may indicate a feature from the one or more features. Further, the sentiment of the user (101) may be classified as a positive sentiment (701), a negative sentiment (702), and a neutral sentiment (703) as shown in FIG. 7. In an embodiment, the positive sentiment (701) may indicate the user (101) is capable of performing the one or more actions at each step of the workflow with ease. The neutral sentiment (703) may indicate the user (101) is capable of performing the one or more actions at each step of the workflow with little effort. The negative sentiment (702) may indicate the user (101) is struggling to perform the one or more actions at each step of the workflow. Further, the assistance system (103) may identify the instance of struggle by the user (101) based on the determined sentiment, and the determined context.

For example, consider the task (102) “Removal of hard disk of a given laptop”. The assistance system (103) based on the determined sentiment (i.e. negative sentiment (702)) and the determined context (unscrewing the screws on the back cover of the laptop) at the step 4 (405) of the workflow (401) may determine the instance of struggle as “User struggling to unscrew the screws on the back of the laptop, because the user is unable to determine the direction for unscrewing the screws”. Similarly, the assistance system (103) at the step 5 (406) of the workflow (401) may determine the instance of struggle as “User struggling to remove the bracket associated with the hard disk for removing the hard disk form the laptop”.

At the step 305, the assistance system (103) may identify a personalized recommendation for the user (101) in real time for performing the one or more actions based on the determined context, and the determined instance of struggle. Further, the personalized recommendation may be provided to the user (101) for completing the task (102).

The assistance system (103) may select the one or more personalized recommendation from a plurality of personalized recommendation stored in the database (105) based on the determined context and the determined instance of struggle by the user (101) to complete a step of the workflow. The plurality of personalized recommendation may be generated based on determined sentiment and the determined context. The personalized recommendation provided to the user (101) may include at least one of an audio suggestion, a video suggestion, a text suggestion, suggestion through animation, or a suggestion through an image. Further, the personalized recommendation comprises one or more steps containing details for performing the one or more actions in each step of the workflow.

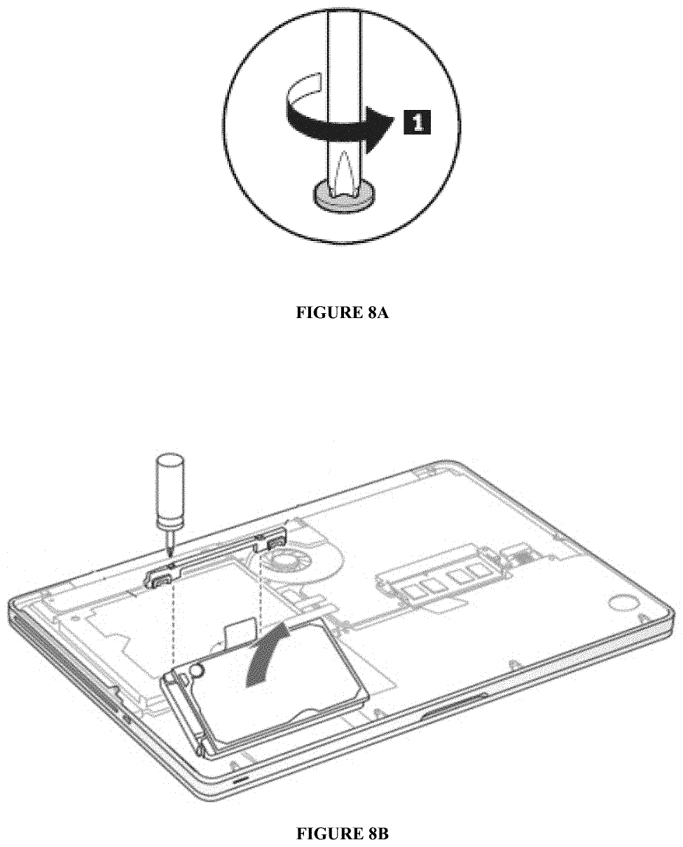

The assistance system (103) for the instance of the struggle identified at the step 304, may select the one or more personalized recommendation from a plurality of personalized recommendation stored in the database (105). For the determined instance of struggle “User struggling to unscrew the screws on the back of the laptop, because the user is unable to determine the direction for unscrewing the screws” the assistance system (103) may provide the personalized assistance for determining the direction of unscrewing in the format of suggested image or suggested video as shown in FIG. 8A. Similarly, for the determined instance of struggle “User struggling to remove the bracket associated with the hard disk for removing the hard disk form the laptop”, the assistance system (103) may provide the personalized assistance for removing the bracket and pulling the hard disk in the format of suggested image or suggested video as shown in FIG. 8B.

### Computer System

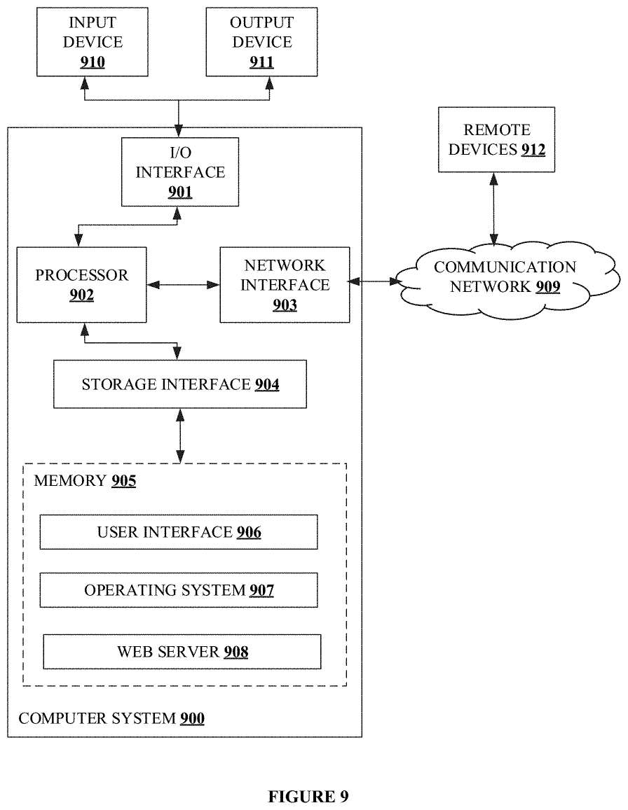

FIG. 9 illustrates a block diagram of an exemplary computer system (900) for implementing embodiments consistent with the present disclosure. In an embodiment, the computer system (900) may be used to implement the method of providing context based personalized assistance. The computer system (900) may comprise a central processing unit (“CPU” or “processor”) (902). The processor (902) may comprise at least one data processor for executing program components for dynamic resource allocation at run time. The processor (902) may include specialized processing units such as integrated system (bus) controllers, memory management control units, floating point units, graphics processing units, digital signal processing units, etc.

The processor (902) may be disposed in communication with one or more input/output (I/O) devices (not shown) via I/O interface (901). The I/O interface (901) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface (901), the computer system (900) may communicate with one or more I/O devices. For example, the input device (910) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device (911) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system (900) is connected to the service operator through a communication network (909). The processor (902) may be disposed in communication with the communication network (909) via a network interface (903). The network interface (903) may communicate with the communication network (909). The network interface (903) may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network (909) may include, without limitation, a direct interconnection, e-commerce network, a peer to peer (P2P) network, local area network (LAN), wide area network (WAN), wireless network (e.g., using Wireless Application Protocol), the Internet, Wi-Fi, etc. Using the network interface (903) and the communication network (909), the computer system (900) may communicate with the one or more service operators.

In some embodiments, the processor (902) may be disposed in communication with a memory (905) (e.g., RAM, ROM, etc. not shown in FIG. 9 via a storage interface (904)). The storage interface (904) may connect to memory (905) including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (905) may store a collection of program or database components, including, without limitation, user interface (906), an operating system (907), web server (908) etc. In some embodiments, computer system (900) may store user/application data, such as the data, variables, records, etc. as described in this disclosure. Such databases may be implemented as fault-tolerant, relational, scalable, secure databases such as Oracle or Sybase.

The operating system (907) may facilitate resource management and operation of the computer system (900). Examples of operating systems (907) include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2°, MICROSOFT® WINDOWS® (XP®, VISTA®/7/8, 10 etc.), APPLE® IOS®, GOOGLE™ ANDROID™, BLACKBERRY® OS, or the like.

In some embodiments, the computer system (900) may implement a web browser stored program component. The web browser may be a hypertext viewing application, such as MICROSOFT® INTERNET EXPLORER®, GOOGLE® CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers (908) may utilize facilities such as AJAX, HTML, ADOBE® FLASH®, JAVASCRIPT®, JAVA®, Application Programming Interfaces (APIs), etc. In some embodiments, the computer system (900) may implement a mail server (not shown in the Figure) stored program component. The mail server may be an Internet mail server such as Microsoft Exchange, or the like. The mail server may utilize facilities such as Active Server Pages (ASP), ACTIVEX®, ANSI® C++/C #, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® Exchange, Post Office Protocol (POP), Simple Mail Transfer Protocol (SMTP), or the like. In some embodiments, the computer system (900) may implement a mail client (not shown in the Figure) stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processors to perform steps or stages consistent with the embodiments described herein. The term “computer-readable medium” should be understood to include tangible items and exclude carrier waves and transient signals, i.e., non-transitory. Examples include Random Access memory (RAM), Read-Only memory (ROM), volatile memory, non-volatile memory, hard drives, Compact Disc (CD) ROMs, Digital Video Disc (DVDs), flash drives, disks, and any other known physical storage media.

In some implementation the request from the user (101) and the captured multimodal data (205) of the user (101) may be received from the remote devices (912).

The method of providing context based personalized assistance includes identifying a struggle of instance of the user (101) and providing personalized assistance to the user (101) for completing each step of the workflow. The assistance system (103) captures multimodal contextual data of the user (101) during each step of the workflow. The assistance system (103) provides a step by step assistance for performing the task (102) and analyzes the multimodal data (205) of the user (101) to determine contextual instances of errors or mistakes done by the user (101) and provides insights and recommendations in real time for the completing the task (102).

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it may be readily apparent that more than one device/article (whether or not they cooperate) may be used in place of a single device/article. Similarly, where more than one device or article is described herein (whether or not they cooperate), it may be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments may be apparent to those skilled in the art. The various aspects and embodiments disclosed herein are for purposes of illustration and are not intended to be limiting, with the true scope and spirit being indicated by the following claims.

What is claimed is:

1. A method of providing context based personalized assistance, the method comprising:
receiving, by an assistance system, a request for assisting a user for performing a task;
providing, by the assistance system, a workflow to the user based on the received request;
receiving, by the assistance system, multimodal data associated with one or more actions performed by the user while performing each step of the workflow;
determining, by the assistance system, a context of the one or more actions and an instance of struggle by the user in performing the one or more actions to complete each step of the workflow based on the received multimodal data based on a machine learning technique; and
identifying, by the assistance system, a personalized recommendation for the user in real time for performing the one or more actions based on the determined context, and the determined instance of struggle, wherein the personalized recommendation is provided to the user for completing the task.

2. The method of claim 1, wherein the workflow provided to the user comprises at least one of an image, a text description, a video, or an animation.

3. The method of claim 1, wherein the multimodal data of the user comprises at least one of a captured image, a captured video, a recorded audio, action logs or interacted text with the assistance system.

4. The method of claim 1, wherein the determining the context comprises:
detecting at least one of one or more objects, and state of the one or more objects in the multimodal data;
detecting the one or more actions performed by the user on the one or more objects;
generating a textual description based on the detected one or more actions and at least one of the one or more objects, and the state of the one or more objects; and
determining the context of the one or more actions using the generated textual description and a domain specific rule.

5. The method of claim 1, wherein the determining the instance of struggle by the user comprises:
determining a sentiment of the user based on the received multimodal data, using a machine learning technique; and
identifying the instance of struggle by the user based on the determined sentiment, and the determined context.

6. The method of claim 1, wherein the identifying the personalized recommendation comprises:
selecting one or more personalized recommendation from a plurality of personalized recommendation based on the determined context and the determined instance of struggle by the user to complete a step of the workflow, wherein the plurality of personalized recommendation is generated based on determined sentiment and the determined context.

7. The method of claim 1, wherein the personalized recommendation provided to the user comprises at least one of an audio suggestion, a video suggestion, a text suggestion, suggestion through animation, or a suggestion through an image.

8. The method of claim 1, wherein the personalized recommendation comprises one or more steps containing details for performing the one or more actions in each step of the workflow.

9. An assistance system, for providing context based personalized assistance, the assistance system comprising:
a processor; and
a memory communicatively coupled to the processor, wherein the memory stores the processor executable instructions, which, on execution, causes the processor to:
receive a request for assisting a user for performing a task;
provide a workflow to the user based on the received request;
receive multimodal data associated with one or more actions performed by the user while performing each step of the workflow;
determine a context of the one or more actions and an instance of struggle by the user in performing the one or more actions to complete each step of the workflow based on the received multimodal data based on a machine learning technique; and
identify a personalized recommendation for the user in real time for performing the one or more actions based on the determined context, and the determined instance of struggle, wherein the personalized recommendation is provided to the user for completing the task.

10. The assistance system of claim 9, wherein the processor is configured to provide the workflow to the user in a format comprising at least one of an image, a text description, a video, or an animation.

11. The assistance system of claim 9, wherein the processor is configured to receive the multimodal data of the user in a format comprising at least one of a captured image, a captured video, a recorded audio, action logs or interacted text with the assistance system.

12. The assistance system of claim 9, wherein the processor is configured to determine the context by:
detecting at least one of one or more objects, and state of the one or more objects in the multimodal data;
detecting the one or more actions performed by the user on the one or more objects;
generating a textual description based on the detected one or more actions and at least one of the one or more objects, and the state of the one or more objects; and
determining the context of the one or more actions using the generated textual description and a domain specific rule.

13. The assistance system of claim 9, wherein the processor is configured to determine the instance of struggle by the user by:
determining a sentiment of the user based on the received multimodal data, using a machine learning technique; and
identifying the instance of struggle by the user based on the determined sentiment, and the determined context.

14. The assistance system of claim 9, wherein the processor is configured to identify the personalized recommendation by:
selecting one or more personalized recommendation from a plurality of personalized recommendation based on the determined context and the determined instance of struggle by the user to complete a step of the workflow, wherein the plurality of personalized recommendation is generated based on determined sentiment and the determined context.

15. The assistance system of claim 9, wherein the processor is configured to provide the personalized recommendation to the user in a format comprising at least one of an audio suggestion, a video suggestion, a text suggestion, a suggestion through animation, or a suggestion through an image.

16. The assistance system of claim 9, wherein the personalized recommendation comprises one or more steps containing details for performing the one or more actions in each step of the workflow.

17. A non-transitory computer readable medium including instructions stored thereon for providing context based personalized assistance, that when processed by at least one processor cause a device to perform operations comprising:
receiving a request for assisting a user for performing a task;
providing a workflow to the user based on the received request;
receiving multimodal data associated with one or more actions performed by the user while performing each step of the workflow;
determining a context of the one or more actions and an instance of struggle by the user in performing the one or more actions to complete each step of the workflow based on the received multimodal data based on a machine learning technique; and
identifying a personalized recommendation for the user in real time for performing the one or more actions based on the determined context, and the determined instance of struggle, wherein the personalized recommendation is provided to the user for completing the task.
